(19) United States
(12) Patent Application Publication
(10) Pub. No.: US 2007/0283812 A1
(43) Pub. Date: Dec. 13, 2007

(54) SYSTEM AND METHOD FOR REMOVING SULFUR FROM FUEL GAS STREAMS

(75) Inventors: Ke Liu, Rancho Santa Margarita, CA (US); Vladimir Zamansky, Oceanside, CA (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, SCHENECTADY, NY (US)

(21) Appl. No.: 11/426,369

(22) Filed: Jun. 26, 2006

Related U.S. Application Data
(60) Provisional application No. 60/804,357, filed on Jun. 9, 2006.

(51) Int. Cl. B01D 53/06

(52) U.S. Cl. 96/150

(57) ABSTRACT

A system for removing sulfur compounds from a gaseous stream includes an adsorption zone comprising a first fluidized bed comprising a sulfur adsorption material configured to receive a fuel gas stream comprising sulfur compounds and to adsorb and remove the sulfur compounds from the fuel gas stream. The system is configured to generate a product stream substantially free of sulfur and a saturated sulfur adsorption material. The system further includes a regeneration zone comprising a second fluidized bed configured to receive an oxidant and steam to regenerate the saturated sulfur adsorption material. The adsorption zone and regeneration zone are in direct fluid communication.

This application claims the benefit of the filing date of provisional application U.S. Ser. No. 60/804,357 filed Jun. 9, 2006.

### BACKGROUND OF THE INVENTION

This invention relates to systems and methods for removing sulfur from fuel gas streams. More particularly, this invention relates to systems and methods for removing sulfur compounds from synthesis gas using fluidized bed reactors.

Many industrial gases contain hydrogen sulfide (H₂S) and carbonyl sulfide (COS). Examples of such fuel gases include, but are not limited to syngas stream from a coal gasifier, hydrocarbon feeds and other processes. One such fuel gas, synthesis gas (syngas), is prepared by reforming or gasification of a carbonaceous fuel by contacting it with an oxidant under high temperature conditions to produce a syngas containing H₂, CO, steam and gaseous contaminants including H₂S, and COS. The carbonaceous fuel can be any of various solid, liquid, or gaseous materials having a substantial elemental content of carbon and hydrogen. Such materials include, for example, coal or petroleum coke, biomass, waste, liquid feedstocks such as heavy naphtha fractions, or gaseous feedstocks such as natural gas. Commercial syngas processes typically include a desulfurization unit to remove H₂S and COS sulfur species from the syngas.

Various desulfurization processes are known in the art. The current commercial process for removing H₂S from steam-containing syngas streams involves cooling the initial product gas to a temperature below its dew point to remove water and then contacting the gas with an aqueous solvent containing amines. However, cooling of a fuel gas stream, such as syngas, reduces the thermal efficiency of the process often making this processing technology less advantageous compared to other competing technologies. Amine-based scrubbing processes also have technical problems such as the formation of thermally stable salts, decomposition of amines, and are additionally equipment-intensive, thus requiring substantial capital investment.

In recent years, substantial research and investment has been directed towards various syngas processes, such as the “Integrated Gasification Combined Cycle (IGCC) and a Coal-to-Liquids process (CTL). IGCC is a process for generating syngas by gasification of solid or liquid fuels, which syngas can be used as the feed in a combined cycle power plant for generation of electricity. CTL uses syngas from coal gasification as a raw material for generation of high-value chemicals or zero-sulfur diesel and gasoline as transportation fuels. Syngas can also be used as a hydrogen source for fuel cells. Although syngas-based technologies offer considerable improvement in both thermal and environmental efficiency, the cost of these technologies is currently impeding market penetration. One approach being investigated to substantially reduce the cost involves the incorporation of a water quench in the gasification process. This water quench readily removes almost all of the solid and chemical contaminants in the syngas. Unfortunately, the treatment does not remove the sulfur, and is not energy efficient as the syngas is typically cooled to remove sulfur through the amine bases presses.

Accordingly, there is a need for a process to remove sulfur from syngas economically at high temperature.

### BRIEF DESCRIPTION OF THE INVENTION

In one aspect, a system for removing sulfur compounds from a gaseous stream includes an adsorption zone comprising a first fluidized bed comprising a sulfur adsorption material configured to receive a fuel gas stream comprising sulfur compounds and to adsorb and remove the sulfur compounds from the fuel gas stream. The system is configured to generate a product stream substantially free of sulfur and a saturated sulfur adsorption material. The system further includes a regeneration zone comprising a second fluidized bed configured to receive an oxidant and steam to regenerate the saturated sulfur adsorption material. The adsorption zone and regeneration zone are in direct fluid communication.

In another aspect, a system for producing a synthesis gas includes a gasifier configured to receive a solid or liquid fuel and an oxidant to produce a synthesis gas comprising sulfur compounds. The system further includes a system for removing sulfur compounds from a gaseous stream including an adsorption zone comprising a first fluidized bed comprising a sulfur adsorption material configured to receive a fuel gas stream comprising sulfur compounds and to adsorb and remove the sulfur compounds from the fuel gas stream. The system is configured to generate a product stream substantially free of sulfur and a saturated sulfur adsorption material. The system also includes a regeneration zone comprising a second fluidized bed configured to receive an oxidant and steam to regenerate the saturated sulfur adsorption material. The adsorption zone and regeneration zone are in direct fluid communication.

In yet another aspect, a method for removing sulfur compounds from a gaseous stream includes adsorbing the sulfur compounds in an adsorption zone comprising a first fluidized bed comprising a sulfur adsorption material configured to receive an fuel gas stream and producing a product stream substantially free of sulfur and a saturated sulfur adsorption material. The method also includes introducing an oxidant and the sulfur adsorption material from the adsorption zone into a regeneration zone comprising a second fluidized bed and regenerating the saturated sulfur adsorption material. The adsorption zone and regeneration zone are in direct fluid communication.

In another aspect, a system for removing pollutants from a gaseous stream includes an adsorption zone comprising a first fluidized bed comprising an adsorption material configured to receive a fuel gas stream comprising the pollutants and to adsorb and remove the pollutants from the fuel gas stream to generate a product stream substantially free of pollutants and a saturated adsorption material. The system further includes a regeneration zone comprising a second fluidized bed configured to receive an oxidant and steam to regenerate the saturated adsorption material. The adsorption zone and regeneration zone are in direct fluid communication and the pollutants comprises at least one of sulfur compounds, chlorine (Cl), ammonia (NH3), mercury (Hg), arsenic (As), selenium (Se), cadmium (Cd) and combinations thereof.

### DESCRIPTION OF THE DRAWINGS

These and other features, aspects, and advantages of the present invention will become better understood when the following detailed description is read with reference to the accompanying drawings in which like characters represent like parts throughout the drawings, wherein;

FIG. 1 is a schematic diagram of an exemplary sulfur removal system;

FIG. 2 is a schematic diagram of an exemplary synthesis gas production system integrated with a sulfur removal system; and

FIG. 3 is a schematic showing the exemplary uses of the synthesis gas produced after the sulfur removal.

### DETAILED DESCRIPTION OF THE INVENTION

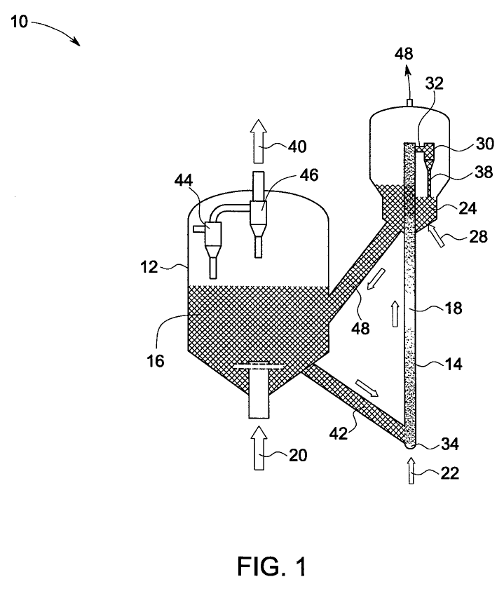

FIG. 1 represents an exemplary system 10 for removing sulfur from a gaseous stream. The system 10 includes an adsorption zone 12 and a regeneration zone 14. The adsorption zone 12 includes a first fluidized bed 16 configured to receive a fuel stream 20 comprising sulfur compounds. The first fluidized bed 16 comprises a sulfur adsorption material (herein after SAM) for adsorption of sulfur compound from the fuel stream 20 and remove the sulfur compound from the fuel stream. The system 10 is configured to generate a product stream 40 substantially free of sulfur and a saturated sulfur adsorption material The regeneration zone 14 includes a second fluidized bed 18 configured to receive an oxidant 22 and regenerate the SAM. The adsorption zone 12 and the regeneration zone 14 are in direct fluid communication with each other.

The system 10 further includes a third fluidized bed 24 in fluid communication with the first fluidized bed 16 and the second fluidized bed 18. The third fluidized bed 24 is configured to receive steam 28 to regenerate the SAM. The second fluidized bed 18 is typically a dilute bed, which dilute bed has a low density of particulates and the third fluidized bed 24 is typically a dense bed with a high density of particulates. In operation, the fluidized beds 18 and 24 are configured to receive the spent SAM from the first fluidized bed 16 and the oxidant 22 to regenerate the SAM.

The regeneration zone 14 further includes a solid separator 30 in fluid communication with the regeneration zone 14. In one embodiment, as shown in FIG. 1, the solid separator 30 is a cyclone separator, which cyclone separator is connected to the regeneration zone 14 via a conduit 32. The oxidant (typically air) 22 is introduced in the regeneration zone 14 through an opening 34. The pressure of the oxidant keeps the second fluidized bed 18 under the required fluidized condition. The pressure of the oxidant should be sufficient enough to generate a high velocity for the fuel, the gases produced in the sulfur adsorption reaction and regeneration reactions and the SAM. The SAM reacts with the oxidant 22 and generates an oxygen-depleted stream 48. The particles of the SAM is carried by the oxidant-depleted stream 48 and is separated by the cyclone separator 30. Once separated; the SAM is fed back to the third fluidized bed 24 via conduit 38. The oxidant depleted stream 48 may further comprise hydrogen sulfide (H₂S) and sulfur dioxide (SO₂).

The system 10 produces a product stream 40 substantially free of sulfur containing species. Substantially free of sulfur is herein defined as the sulfur content of ppm level in the product stream 40 coming out of the adsorption zone 12 of less than about 50 ppm. The SAM reacts with the sulfur species in the fuel stream 20 and is capable of going through cycles of sulfur adsorption reaction and regeneration reaction. The fuel gas stream 20 may comprise natural gas, methane, butane, propane, diesel, kerosene, synthesis gas from reforming or gasification of coal, petroleum coke, bio-mass, waste, gas oil, crude oil, and mixtures thereof. In some embodiments, the fuel gas stream 20 is synthesis gas produced from coal gasification such as the gasifier in an IGCC power generation plant.

Typically the SAM is a metal oxide comprising at least one metal selected from the group consisting of zinc (Zn), magnesium (Mg), molybdenum (Mo), manganese (Mn), iron (Fe), chromium (Cr), copper (Cu), nickel (Ni), cobalt (Co), cerium (Ce), and combinations thereof. In some embodiments, the SAM comprises mainly zinc oxide (ZnO) and a small amount of Iron oxide (FeO) for releasing the heat for the regeneration step. In such embodiments, the main reactions in the adsorption zone 12 are the following:

ZnO+H₂S→ZnS+H₂O (1)

FeO+CO→Fe+CO₂ (2)

FeO+H₂Fe+H₂O (3)

The sulfur containing species in the fuel stream 20 include, but are not limited to hydrogen sulfide (H₂S) and carbonyl sulfide (COS). As shown in reaction 1 above, the H₂S reacts with the ZnO and forms zinc sulfide (ZnS) in the adsorption zone 12. The spent SAM saturated with sulfur flows to the regeneration zone 14 under gravity through a conduit 42. The main reactions in the regeneration zone 14 in this case are the following:

Fe+O₂→FeO+Heat (4)

ZnS+O₂+H₂O+Heat→ZnO+SO₂+H₂S (5)

ZnS+H₂O→H₂S+ZnO (6)

The temperature of the fuel stream 20 ranges from about 100 Deg. C. to about 350 Deg C. In operation, the reactions 1-3 as shown in the adsorption zone 12 generate heat, which heat raises the temperature of the first fluidized bed 16 to between about 250 Deg. C. to about 450 Deg. C. As a result, the product stream 40 generated from the adsorption zone 12 is at between about 250 Deg. C. to about 450 Deg. C. In some embodiments, in case any additional heat for reaction (5) is needed, a relatively small volume of an oxidant such as air or O₂ may be introduced into the regeneration zone 14. The temperature in the regeneration zone 14 ranges from about 250 Deg C. to about 450 Deg C. In certain embodiments, the fuel stream 20 comprises synthesis gas and the product stream 40 is essentially a synthesis gas substantially free of sulfur. The temperatures of this product stream 40 is ideal for introducing the synthesis gas into a gas turbine (not shown) to generate power. Therefore the system 10 generates synthesis gas at an appropriate temperature for power generation in a gas turbine without incorporating any additional heating device as required by current sulfur removal processes.

In some embodiments, The SAM comprises oxides of Mn and Mg, wherein the adsorption zone 12 is configured to operate between about 300 Deg C. to about 600 Deg C. In the systems described so far in the preceding sections, the particle size of the SAM ranges from about 40 microns to about 350 microns.

In some embodiments the presence of certain metals in the SAM including but not limited to Fe, Ni and Cr act as a catalyst and promote the water gas shift reaction (WGS) in the adsorption zone 12. In one embodiment, a WGS catalyst is loaded via ion-exchange process onto the SAM and introduced in the first fluidized bed 16. In another embodiment, the particles of SAM may be physically mixed with the WGS catalyst particles. In another embodiment, a WGS catalyst can be wash-coated onto the SAM. The WGS reaction is shown in the reaction given below.

CO+H₂O [symbol] CO₂+H₂ (7)

In some embodiments, the water-gas-shift reaction forming carbon dioxide (CO₂) may also occur depending on the availability of steam. In some embodiments, the third fluidized bed 24 may also be operated without additional steam feed 28. However, in the absence of additional steam, the WGS reaction utilizes the steam generated through the reaction 3 in the adsorption zone 12. However, in certain embodiments as shown in FIG. 1, it is desirable to supply additional steam to enhance the WGS activity. As shown in FIG. 1, in operation, the SAM flows under gravity to the regeneration zone 14 through a first conduit 42. In one embodiment, the regeneration zone 14 includes a riser tube reactor.

The adsorption zone 12 is in fluid communication with at least one solid separator to separate the particles flowing up from the first fluidized bed 16. In some embodiments, as shown in FIG. 1, the adsorption zone 12 comprises two-stage closed cyclones 44 and 46 to separate the particles rising from the first fluidized bed 16. Optionally, separators 44 and 46 (as well as 30) may be located outside of the fluidized bed reactors. The regenerated SAM flows down to the adsorption zone 12 through conduits connected to the cyclones.

As discussed earlier, the inorganic metal oxide may or may not be active for catalyzing WGS reactions. If a given inorganic metal oxide used in the process described above is not active for the WGS reaction, a second catalytic component, for example a Cu—Zn WGS catalyst or a nickel steam reforming catalyst, that is active for steam reforming reaction may be added. This second component can be placed on the same carrier particle as the inorganic metal oxide or on a separate carrier particle.

For use in the fluidized beds, the particle sizes of the SAM is generally in the range between about 10 to about 400 microns, and more specifically between about 40 to about 250 microns. In some embodiments, the SAM may be configured to perform more than one function. The main functions of the SAM may be one or more of sulfur removal, catalyst for WGS reaction and also CO₂ adsorption.

In some embodiments, optionally, fine particles of carbon dioxide (CO₂) adsorbents can be added to the catalyst to remove the CO₂ formed in the reforming reactions. Typically calcium oxide (CaO) or magnesium oxide (MgO) or their combinations may be used in industrial processes for adsorbing CO₂ produced in the reforming or WGS reactions. For example, in the embodiments using CaO, its utilization is low due to the calcium carbonate (CaCO₃) eggshell formation that prevents further utilization of CaO in a relative big CaO particle (in the range of about 1 to 3 mm). The big CaO particles become fines after many chemical cycles between CaO and CaCO₃. In conventional adsorption process, another metal oxide is introduced as a binder to avoid the CaO fines formation. But the cost of CO₂ adsorbent increases significantly due to this modification. In the current technique as described in the preceding sections, instead of trying to avoid the CaO fines formation, the system design and the process catalyst system are adjusted to effectively utilize CaO fines as the CO₂ adsorbent. Instead of avoiding fines, the disclosed process effectively uses catalyst fines and CaO fines in the range of about 20 micron to about 250 micron. The CO₂ adsorption material is configured to capture CO₂ in the adsorption zone releasing heat of CO₂ adsorption. The CO₂ adsorption material can capture CO₂ in the adsorption zone 12 based on reactions such as:

CO₂+CaO→CaCO₃ (8)

Ca(OH)₂+CO₂→CaCO₃+H₂O (9)

Calcium hydroxide Ca(OH)₂ also contributes towards removing sulfur from H₂S as per the reaction (10) given below:

Ca(OH)₂+H₂S→CaS+2H₂O (10)

The release of CO₂ in the regeneration zone 14 to regenerate the CO₂ adsorption material is based on reactions 11-14 as given below:

CaCO₃→CaO+CO₂ (11)

CaCO₃+H₂O→CO₂+Ca(OH)₂ (12)

CaS+O₂→CaO+SO₂ (13)

CaS+H₂O→Ca(OH)₂+H₂S (14)

The types of fluidized bed processes that can be used herein include fast fluid beds and circulating fluid beds. The circulation of the SAM can be achieved in either the up flow or down flow modes. A circulating fluid bed is a fluid bed process whereby metal oxide and any other particles are continuously removed from the bed (whether in up flow or down flow orientation) and are then re-introduced into the bed to replenish the supply of solids. At lower velocities, while the inorganic metal oxide is still entrained in the gas stream, a relatively dense bed is formed in the systems described above. This type of bed is often called a fast fluid bed.

In some embodiments, the synthesis gas 20 described in the previous sections typically comprises hydrogen, carbon monoxide, carbon dioxide, and steam. In some embodiments, the synthesis gas further comprises un-reacted fuel. The oxidant 22 used in the disclosed systems may comprise any suitable gas containing oxygen, such as for example, air, steam, oxygen rich air or oxygen-depleted air and a mixture of steam and air.

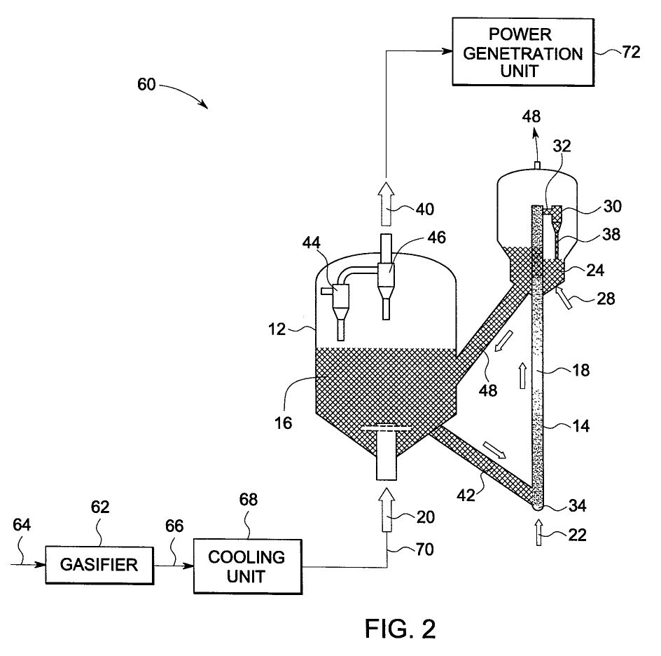

FIG. 2 represents an exemplary system 60 for producing a synthesis gas 40, wherein the synthesis gas 40 is produced in a gasifier 62. A fuel 64 is supplied into the gasifier 62, producing hot synthesis gas 66 at a temperature between about 1100 Deg. C. to about 1400 Deg. C. The hot synthesis gas 66 is cooled in a cooling unit 68 configured to bring down the temperature of the hot synthesis gas 66 to about 450 to 100 Deg. C. and produce a cooled synthesis gas 70. The cooling unit 68 may comprise a radiant gas cooler or any conventional cooler (not shown), often for generating steam for power generation. The cooled synthesis gas 70 is introduced into the sulfur removal unit 10 as described in the preceding sections. The product gas 40 from the adsorption zone 12 of the sulfur removal system 10 is introduced into a power generation unit 72 for generating power. The system described in the preceding sections may also be used for synthesis gas clean up at high temperature to remove other pollutants such as Chlorine (Cl), ammonia (NH₃), mercury (Hg), arsenic (As), selenium (Se) and cadmium (Cd).

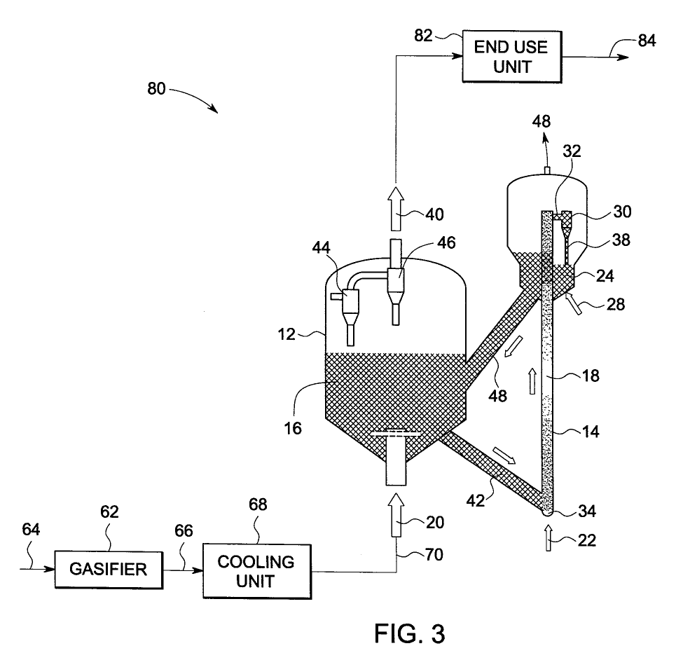

FIG. 3 illustrates a system 80, which system 80 combines the syngas generation system of FIG. 2 and an end use unit 82. The end use unit 82 may be a coal to liquid plant utilizing the syngas 40 and produces liquids 84. In some other embodiments, the end use unit 82 is a hydrogen generation unit and may produce hydrogen 84.

In some embodiments, the fuel stream 20 comprises sulfur-containing species such as COS. The system 10 as described above is capable of either adsorb or hydrolyzing the COS present in the fuel stream 20 thereby removing the sulfur compounds.

There are several ways the SAM may be manufactured to get the right particle size and the properties desired. The main properties for the SAM to be used in fluidized bed reactors are capability to adsorb sulfur, attrition resistance, capability to withstand high temperature and sufficient surface area for facilitating the adsorption and regeneration process. In order to manufacture the SAM, in some embodiments, an organic or inorganic binder is used along with water and a surfactant to make a slurry. The metal precursor (such as ZnO) is added to the slurry and the slurry is then spray dried and heated from about 300 Deg. C. to about 600 Deg. C. The particles are subsequently calcined at between about 700 Deg. C. to about 900 Deg. C. to get more attrition resistance property for the sulfur adsorption material (SAM).

In some other embodiments small amounts of Fe or Ni are mixed into slurry comprising MnO and/or ZnO. After uniformly mixing the slurry, the mixture is crystallized, filtered and dried to form the Zn—Fe oxide or Mn—Fe oxide SAM particles. If solutions of different Fe and Zn salts are used in the slurry, Fe and Zn may be mixed at a molecular level, so that the zinc oxide site is be next to Fe oxide site.

As discussed above, one issue with conventional sulfur removal systems is that they are complex, inefficient and have an extremely large footprint. The systems described herein reduce the overall complexity of sulfur removal processes; improve the operating efficiencies of these processes; and provide a much simpler system and smaller overall footprint.

The sulfur removal process contributes a major portion towards the capital cost of the IGCC, CTL and coal to hydrogen plants, or any other plants that requires removal of sulfur compounds from syngas. In order to remove sulfur by the conventional amine process, the synthesis gas exiting the gasifier is typically cooled down through multiple steps to approximately room temperature, which cooling process is very capital intensive and inefficient. After the gasifer, almost all the sulfur in the coal is converted to H₂S. There are many H₂S removal process available using Zn or Mn oxides which removal process are used in ammonia, H₂ and fuel cell industries for natural gas (NG) feed. Since the sulfur level is low in NG and the ZnO is cheap, the regeneration of the adsorption material is not critical in these applications. However, due to the presence of a very high level of sulfur in coal, regeneration of the sulfur adsorption material is critical. It is not feasible in this application to stop the plant frequently, replace the adsorbent and dispose off the huge amount of adsorbent as chemical waste without regeneration. The sulfur removal processes described herein provides a low cost sulfur removal technology for IGCC, coal to H₂ and coal to liquids plants at high temperature, and other applications. This process eliminates multiple cooling steps and unit operations of the conventional sulfur removal processes. The techniques described in the preceding sections do not involve any moving parts or temperature swing techniques used in the conventional amine process, thereby increasing the reliability of the sulfur removing process. Thus the system for sulfur removal described in the preceding sections that couples the sulfur adsorption and regeneration into a single circulation fluidized bed unit can meet all the important technical challenges for reducing the cost and increases the efficiency of IGCC, CTL and coal to hydrogen plants. The sulfur removal processes described herein may also be used to remove chlorine and acid gas pollutants present in the fuel stream.

Various embodiments of this invention have been described in fulfillment of the various needs that the invention meets. It should be recognized that these embodiments are merely illustrative of the principles of various embodiments of the present invention. Numerous modifications and adaptations thereof will be apparent to those skilled in the art without departing from the spirit and scope of the present invention. Thus, it is intended that the present invention cover all suitable modifications and variations as come within the scope of the appended claims and their equivalents.

What is claimed is:

1. A system for removing sulfur compounds from a gaseous stream comprising:
an adsorption zone comprising a first fluidized bed comprising a sulfur adsorption material configured to receive a fuel gas stream comprising sulfur compounds and to adsorb and remove said sulfur compounds from said fuel gas stream to generate a product stream substantially free of sulfur and a saturated sulfur adsorption material; and
a regeneration zone comprising a second fluidized bed configured to receive an oxidant and steam to regenerate said saturated sulfur adsorption material;
wherein said adsorption zone and regeneration zone are in direct fluid communication.

2. The system of claim 1, wherein said sulfur adsorption material comprises zinc oxide and optionally iron oxide.

3. The system of claim 1, wherein said sulfur compound comprises hydrogen sulfide (H₂S) and carbonyl sulfide (COS).

4. The system of claim 1, wherein said adsorption zone operates at a temperature of about 150 Deg. C. to about 450 Deg. C.

5. The system of claim 1, wherein said first fluidized bed comprises a catalyst to catalyze at least one of a water-gas-shift reaction or a steam reforming reaction.

6. The system in claim 1, wherein said first fluidized bed further comprises a CO₂ adsorption material.

7. The system in claim 6, wherein said CO₂ adsorption material is a metal oxide.

8. The system in claim 7, wherein said CO₂ adsorption material comprises calcium oxide (CaO), magnesium oxide (MgO) or combinations thereof.

9. The system of claim 1, wherein said sulfur adsorption material comprises at least one metal selected from the group consisting of Zn, Mg, Mo, Mn, Fe, Cr, Cu Co, Ce, Ni and combinations thereof.

10. The system of claim 5, wherein said catalyst comprises at least one catalytically active metal selected from the group consisting of Rh, Pt, Pd, Ru, Ir, Re, Os and combinations thereof.

11. The system of claim 1, wherein said sulfur adsorption material is configured to perform at least one function selected from the group consisting of sulfur adsorption function, CO₂ adsorption function, water-gas-shift function and/or steam reforming function and combinations thereof.

12. The system of claim 1, wherein said sulfur adsorption material is produced by a spry-drying process followed by calcination at the temperature range of about 700 Deg. C. to about 900 Deg. C.

13. The system of claim 6, wherein particles of said sulfur adsorption material is in the range of about 10 microns to about 400 microns.

14. The system of claim 6, wherein particles of said sulfur adsorption material is in the range of about 40 microns to about 250 microns.

15. The system of claim 5, wherein said catalyst is configured to facilitate a water gas shift reaction to convert carbon monoxide (CO) to produce hydrogen (H₂), and carbon dioxide (CO2).

16. The system of claim 1, wherein said fuel gas is selected from the group consisting of syngas, natural gas, methane, naphtha, butane, propane, diesel, kerosene, an aviation fuel, syngas from gasification of coal, petroleum coke, bio-mass, waste, gas oil, crude oil, an oxygenated hydrocarbon feedstock, and mixtures thereof.

17. The system of claim 1, wherein said saturated sulfur adsorption material is introduced into said regeneration zone through gravity flow.

18. The system of claim 1, wherein said regeneration zone comprises a riser reactor.

19. The system of claim 1, wherein said system further comprises a dense third fluidized bed in fluid communication with said first and second fluidize bed.

20. The system of claim 19, wherein said third fluidized bed is configured to receive steam.

21. The system of claim 1 further comprising at least one first solid separation unit in fluid communication with said adsorption zone and a second solid separation unit in fluid communication with said regeneration zone.

22. The system of claim 21, said first and second solid separation units comprise a two-stage closed cyclone configured to separate particles of said sulfur adsorption material to minimize the loss of said sulfur adsorption material.

23. The system of claim 1, wherein said oxidant is selected from air, steam, oxygen depleted air, oxygen enriched air and mixture of air and steam.

24. The system of claim 1, wherein said fuel gas is synthesis gas.

25. The system of 24, wherein said synthesis gas is produced from gasification of solid and/or liquid fuels, such as coal, biomass, waste, oil and fuels derived from them.

26. The system of claim 24, wherein said synthesis gas is used in a power generation unit, coal to liquid plant, a hydrogen generation unit or combinations thereof.

27. A system for producing a synthesis gas comprising;
a gasifier configured to receive a solid or liquid fuel and an oxidant to produce a synthesis gas comprising sulfur compounds;
a system for removing sulfur compounds from a gaseous stream comprising:
an adsorption zone comprising a first fluidized bed comprising a sulfur adsorption material configured to receive a fuel gas stream comprising sulfur compounds and to adsorb and remove said sulfur compounds from said fuel gas stream to generate a product stream substantially free of sulfur and a saturated sulfur adsorption material; and
a regeneration zone comprising a second fluidized bed configured to receive an oxidant and steam to regenerate said saturated sulfur adsorption material;
wherein said adsorption zone and regeneration zone are in direct fluid communication.

28. The system of claim 27, wherein said synthesis gas is produced from gasification of solid or liquid fuels selected from the group consisting of coal, biomass, waste and oil.

29. A method for removing sulfur compounds from a gaseous stream comprising:
adsorbing said sulfur compounds in an adsorption zone comprising a first fluidized bed comprising a sulfur adsorption material configured to receive an fuel gas stream and producing a product stream substantially free of sulfur and a saturated sulfur adsorption material; and
introducing an oxidant and said sulfur adsorption material from said adsorption zone into a regeneration zone comprising a second fluidized bed and regenerating said saturated sulfur adsorption material;
wherein said adsorption zone and regeneration zone are in direct fluid communication.

30. A system for removing pollutants from a gaseous stream comprising:
an adsorption zone comprising a first fluidized bed comprising an adsorption material configured to receive a fuel gas stream comprising said pollutants and to adsorb and remove said pollutants from said fuel gas stream to generate a product stream substantially free of pollutants and a saturated adsorption material; and
a regeneration zone comprising a second fluidized bed configured to receive an oxidant and steam to regenerate said saturated adsorption material;
wherein said adsorption zone and regeneration zone are in direct fluid communication and said pollutants comprises at least one of sulfur compounds, chlorine (Cl), ammonia (NH₃), mercury (Hg), arsenic (As), selenium (Se), cadmium (Cd) and combinations thereof.
